(19) United States
(12) Patent Application Publication
(10) Pub. No.: US 2014/0076852 A1
(43) Pub. Date: Mar. 20, 2014

(54) Electrical Contacts, Manufacturing Methods Thereof, Electrodes, Vacuum Interrupters, and Electric Power Switches

(71) Applicant: Hitachi, Ltd., Tokyo (JP)

(72) Inventors: Shigeru KIKUCHI, Tokyo (JP); Ayumu MORITA, Tokyo (JP); Kenji TSUCHIYA, Tokyo (JP); Masato YABU, Tokyo (JP); Akio NAKAZAWA, Tokyo (JP)

(73) Assignee: Hitachi, Ltd., Tokyo (JP)

(21) Appl. No.: 13/973,690

(22) Filed: Aug. 22, 2013

(30) Foreign Application Priority Data
Sep. 14, 2012 (JP) 2012-202192

(51) Int. Cl. H01H 1/025; H01H 1/029

(52) U.S. Cl. CPC H01H 1/025; H01H 1/029
USPC 218/130; 200/265

(57) ABSTRACT

Provided an electrical contact is cheap, excellent workability and lasts the effect of chopping current reduction. An electrical contact comprising a Cu matrix, and compounds Cu and low melting point metal which are dispersed in the Cu matrix, wherein a vapor pressure of the low melting point metal is more than 10⁵ Pa at 1000° C., the compound has stoichiometric ratio which is the value of the low melting metal/Cu is greater than 0.5, and a longitudinal direction of the compound is oriented at an angle of 90°±10° to the contact surfaces. The method of the electrical contact is stretching mixture the Cu matrix with the compounds at 70-85% while heating, using as a contact surfaces of the electrical contact.

### TECHNICAL FIELD

The present invention relates to electrical contacts, manufacturing methods thereof, electrodes, vacuum interrupters, and electric power switches.

### BACKGROUND ART

Vacuum switchgears for power distribution turn on electricity and cut it off in a container called a vacuum interrupter by contacting or dissociating a pair of electrical contacts arranged face to face. The electrical contacts such as electromagnetic contactors, open and close frequently under low-voltage and low-current, and require a small chopping current (i.e., low surge). In the case of large chopping current, when the vacuum interrupter is applied to the inductive circuit, and the current is cut off, an abnormal surge voltage is generated, which causes the breakdown of a loading apparatus. Ag—WC-Co-based electrical contacts are commercially available as electrical contacts with low surge and small chopping current. Ag—WC—Co-based electrical contacts can keep stability when low surge are cut off several times. However, Ag—WC—Co-based electrical contacts are expensive because these contacts contain Co (a rare metal) and Ag. Further Ag—WC—Co-based electrical contacts do not work well because WC is a hard material, there are problems in terms of productivity and cost.

On the other hand, Cu—Te-based electrical contacts have lower-priced components, are soft and have excellent workability as the contact material. For example, in Patent Literature 1, since Cu₂Te is distributed in a Cu matrix and Cu₂Te has specific shape and direction, electrical contacts of small consumption and stable contact resistance characteristics can be obtained.

### CITATION LIST

### Patent Literature

Patent Literature 1: JP-A-2006-144031

### SUMMARY OF INVENTION

### Technical Problem

Patent Literature 1 for Cu—Te-based contact shows that Cu₂Te particles of longitudinal shape are oriented substantially parallel to the contact surfaces. Cu₂Te particles are decomposed by arc heating during current interruption, and have the effect of reducing chopping current by volatilization of Te. However, since the stoichiometric composition ratio of Te and Cu (Te/Cu) is 1/2, amount of Te is relatively small, the effect of chopping current reduction is not sufficient, low surge cannot be maintained when Te is volatilized by the current interruption.

Electrical contacts that are dispersed Cu₄Te₇ compounds in Cu (stoichiometric composition ratio Te/Cu is greater than 1/2) were fabricated, and the chopping current was measured. The initial chopping current was very small, 0.7 A (at 1 kA cut off); however, since the size of the particles Cu₄Te₇ and dispersion state were uneven, the desired chopping current could not be obtained stably and sustainably.

An object of the present invention is to provide an electrical contact that is cheap, has excellent workability and stability, and has reduced chopping current.

### Solution to Problem

An electrical contact includes a Cu matrix, and compounds containing Cu and a low melting point metal that are dispersed in the Cu matrix, wherein a vapor pressure of the low melting point metal is more than 10⁵ Pa at 1000° C., where the compound has a stoichiometric ratio that is the value of the low melting metal/Cu is greater than 0.5, and a longitudinal direction of the compound is oriented at an angle of 90°±10° to the contact surfaces.

The method of an electrical contact includes a Cu matrix, and compounds containing Cu and a low melting point metal that are distributed in the Cu matrix, wherein vapor pressure of the low melting point metal is more than 10⁵ Pa at 1000° C., stoichiometric composition ratio (low melting point metal/Cu) of the compound of the low melting point metal with Cu is greater than 0.5, and stretching mixture the Cu matrix with the compounds is at 70-85% while heating, using as a contact surfaces of the electrical contact.

### Advantageous Effects of Invention

According to the invention, the electrical contact is cheap, has excellent workability and stability, and has reduced chopping current.

### BRIEF DESCRIPTION OF DRAWINGS

FIG. 1 is a sectional view of structures of an electrode according to the present invention.

FIG. 2 is a sectional view of structures of electrical contacts according to the present invention;

FIG. 3 is a sectional view showing the structure of a vacuum interrupter according to an embodiment 2; and

FIG. 4 is a sectional view showing the structure of a vacuum connector according to an embodiment 3.

### DESCRIPTION OF EMBODIMENTS

As mentioned above, the electrical contact that was distributed Cu—Te compounds whose stoichiometric composition ratio (Te/Cu) was greater than 1/2, showed a very small chopping current. However, if the size of the Cu—Te compound particles and the dispersion state were not uniform, the desired chopping current could not be obtained stable and sustainably.

Based on this finding, the electrical contact of the present invention is formed with a Cu matrix and the compounds of a low melting point metal and Cu, where the vapor pressure of the low melting point metal is more than 10⁵ Pa at 1000° C., stoichiometric composition ratio of the compound with the low melting point metal and Cu (low-melting-point metal/Cu) is greater than 0.5, the compound forms a needle-like shape, and the longitudinal direction is oriented in the range of 90°±10° to contact surfaces.

The vapor pressure at 1000° C. of the low-melting-point metal is more than 10⁵ Pa; for this reason, the low melting point metal is decomposed from the compound by arc heating occurred during the current interruption; when the low melting point metal is volatilized, it becomes a connecting medium of arc, and delays the current interruption, thus reducing the chopping current. For the low melting point metal content in the compound, the stoichiometric composition ratio (low melting point metal/Cu) is preferably large; the above effect can be obtained if it is larger than 0.5. Further, as this compound is in a needle-like shape, the longitudinal axis is oriented substantially perpendicular to the contact surface, it has the contact surfaces near the source volatilization of the low melting point metal without interruption, the above effect is exhibited.

The low melting point metal is preferably Te or Se, e.g., the compound is Cu₇Te₄, Cu₄Te₃, CuTe or Cu₃Se₂. At least one of these may be mixed. The compound content in the electrical contact is preferably 3 to 10 wt %. The effect of chopping current reduction is insufficient if the content is less than 3 wt %. The volatilization amount of the low melting point metal is increased and other electrical characteristics, such as withstanding voltage may be reduced, if the content is greater than 10 wt %. Further, 90 vol % or more of the compound is 2 to 15 μm of diameter (x), the ratio (y/x) of the length (y) and diameter (x) is 2 to 10. As described above, compounds having this size and shape, and oriented substantially perpendicular to the contact surface, the compounds as the volatilization source of the low melting point metal, exist in the vicinity of the contact surfaces continually.

Further, this compound is preferably dispersed parallel to the contact surface at 6 pieces per 0.01 mm² or more. The arc that is generated during the current interruption, occurs in a cylindrical shape having a diameter of several mm. Since the compounds exist in the number per unit area listed above, even if the cylindrical arc is generated at the location of one of the electrical contacts, the compounds as the volatilization source of the low melting point metal in the arc exist, the effect of the chopping current reduction can exist stably.

The above structure can be obtained by plastic-working dissolution materials of Cu and the low melting point metal as raw materials in a 70-85% reduction of area. That is, the dissolved materials manufactured by casting or the like are stretched by plastic-working, for example, rolling, extrusion, drawing, etc. At this time, since the electrical contacts have a disk shape, after the dissolved material of disk-shape is produced, that is reduced in diameter so as to be a 70-85% reduction area of the circular cross-section by using a plastic-working, such as extrusion, pulling, swaging, etc. Further, preferably, this plastic working is preferably a hot working to prevent defects such as cracks. The temperature is preferably more than 600° C.; this temperature is the annealing temperature of Cu in general. If the reduction area is lower than 70%, the desired structure having needle-like compounds dispersed in a Cu matrix phase in the above orientation and dispersion cannot be obtained. If the reduction area is greater than 85%, the needle-like compounds are divided, the above dimensions and shape cannot be obtained, and the degree of processing is too large, leading to an increase in defects such as cracks overall.

In this way, a small-diameter circular section of the dissolved materials after plastic working, namely, the surface having a 70-85% reduction of area is used as the contact surface (arc generating surface). Due to this, the needle-like compound is oriented substantially perpendicular to the contact surface, and the compounds as volatilization source of the low melting point metal, exist in the vicinity of the contact surface continually. It is possible to maintain the above effect of reducing the chopping current. In addition, it is also possible to obtain a base material by adding directly the compounds of the low melting point metal and Cu. For example, by mixing Cu₄Te₇ compound powder and Cu powder, pressing and sintering it, a composite of Cu₄Te₇ compounds and Cu is manufactured. After that, by plastic working of the above composite, a similar structure can be obtained.

In addition, the disc-shaped electrical contact preferably has a center hole formed at the circle center, and a plurality of piercing slit grooves. The slit grooves are formed toward the outer peripheral portion from the circle center in a non-contact with the center hole. By having a windmill-like shape, the arc generated between the electrical contacts is driven to the outer peripheral side of the contact by an electromagnetic force, and melting layer caused by arc heating can be removed to the outer peripheral side of the contact. That is, if an arc occurs, the contact surface is melted into depth of several μm, the compound is decomposed, low-melting-point metal is stripped; thus it is possible to reduce the chopping current. However, the melting and solidification layer are solidified after the arc extinguished, compound including low content of low-melting-point is left on the melting and solidification layer, the effect of a low surge is not sufficient. However, because of the driving of the arc, when the melting layer is flicked to the outer peripheral side of the contact, is removed, since the compounds as the vaporization source of the low melting point metal are present on the contact surface without a break at the next current interruption, even if the current is cut off many times, it is possible to maintain low surge.

The back of electrical contacts (opposite side of the contact surface) having an arc driving action are joined to the conduction member called an electrode bar by using such as brazing, the electrode of the present invention is obtained. In addition, if interrupting current is small (generally 1 kA or less), enough effect of reducing chopping current can be obtained if the electrical contact is a simple disk-shape without the slit groove. However, since the thickness of melting and solidification of the layer increases as the cut off frequency increases, the above windmill-like shape is effective in stable maintenance of low surge.

The vacuum interrupter includes a movable electrode and the fixed-side pair of electrodes in a vacuum chamber; at least one of them is composed of an electrode using the electrical contact of the present invention. Further, the vacuum switchgear such as an electromagnetic contactor and a vacuum contactor according to the present invention is connected in series by vacuum interrupter, and includes a switching apparatus for driving the movable electrode. Thus, the electrical contact of the present invention is cheap and has excellent workability, and vacuum switching devices with this electrical contact can keep low surge stably.

The present invention is explained in detail below with reference to embodiments. However, the present invention is not limited to these embodiments.

### Embodiment 1

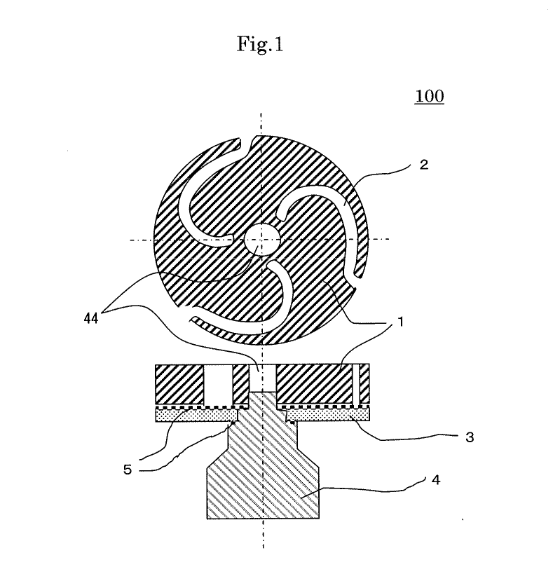

An electrical contact of composition set forth in Table 1 was manufactured, and electrode 100 was manufactured by using this electrical contact. FIG. 1 shows a top view and vertical cross-sectional view that shows the structure of the manufactured electrode 100. In FIG. 1, 1 represents electrical contacts, 2 represents a slit groove to give the arc driving force, 3 represents a reinforcing plate made of stainless steel, 4 represents an electrode bar, 5 represents brazing material, 44 represents a center hole to prevent from stagnation of the arc occurred at the center of the electrical contact 1.

A manufacturing method for the electrical contact 1 shown in Table 1 is described below. In Nos. 1 to 4 and Nos. 6 to 9, Cu₇Te₄ as compounds were dispersed into a copper matrix. Oxygen-free copper and Te powder (particle size 45 μm or less) were injected into a graphite crucible, were heated to 1100 to 1200° C. in a vacuum, and were dissolved. Dissolved material with a diameter of 70 mm was manufactured. In this dissolution process, Cu and Te were reacted and, Cu₇Te₄ was dispersed into copper matrix.

In No. 5 and No. 10, CuTe or Cu₂Te were dispersed into the copper matrix. Cu powder (particle size 60 μm or less), CuTe powder and Cu₂Te powder were mixed (both powder sizes were 40 μm or less), were filled into a mold with a diameter of 70 mm, were molded under pressure at 294 MPa, and were heated for 2 hours at 1065° C. in a vacuum. A sintered material with a diameter of 70 mm was obtained. In this method, CuTe or Cu₂Te particles were dispersed into the copper matrix.

The obtained the dissolved material and the sintered material were heated at 700° C. in atmosphere, were gradually made into small diameter by swaging (rotary forging), were a given reduction of area by plastic-working, and were cut in round slices to be a parallel to the circular surface. The electrical contact 1 was obtained.

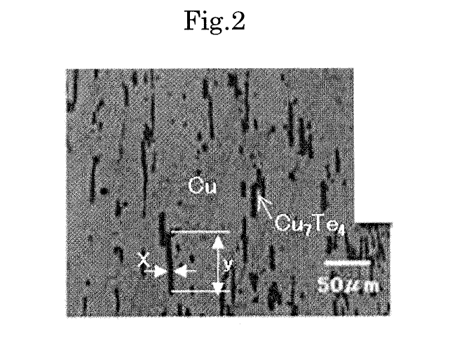

A result obtained by observing a circular surface (contact face) of the obtained electrical contact 1 and a perpendicular cross section to the contact face with an optical microscope, measuring the compound structure by using a image processing device, is shown in Table 1. FIG. 2 shows an example of a state of the material in the longitudinal sectional view of the electrical contact 1. In Nos. 1 to 5, the diameter (x) of the lateral direction of the compound was 2 to 15 μm, the ratio (y/x) of a longitudinal diameter (y) to the length (x) was 2 to 10, longitudinal direction orientate in the range of 90°±10° against contact surface, and was dispersed in the Cu matrix at a ratio of 6/0.01 mm² or more. On the other hand, in No. 6, the content of the compound was small; for this reason, the proportion of compound particles was insufficient in a plane parallel to the contact surface. In addition, in No. 8, since reduction of area was small, the compound particle size was large, the ratio of y/x was not sufficient, the proportion was also not sufficient. In No. 9, since the reduction of area was too large, the needle-shaped of the compound particles was sufficient, but cracking occurred frequently upon plastic-working. As a result, it was impossible to have enough material to provide for subsequent valuation.

The obtained material was machined, and the electrical contact 1 of 30 mm in diameter in FIG. 1 was manufactured. The constitutional element of electrical contact 1 in embodiment 1 was relatively soft material such as Cu and Te. For this reason, there was no hardly workability such as Ag—WC—Co, machining was relatively easy. As for No. 4, the electrical contact 1 having a simple disk-shape with no slit grooves was manufactured to compare the effect of contact shape (presence or absence of the slit groove) with No. 2.

Manufacturing means for the electrode 100 is as follows. In advance, electrode rod 4 was produced by machining using oxygen-free copper, reinforcing plate 3 was produced by machining using SUS304. Brazing material 5 was disposed between each of the electrical contact 1, the reinforcing plate 3, the welding rod 4; they were heated to 970° C. for 10 minutes in a vacuum of less than 8.2×10⁻⁴ Pa. The electrode 100 shown FIG. 1 was manufactured. If strength of the electrical contact 1 is sufficient, the reinforcing plate 3 may be omitted.

### Embodiment 2

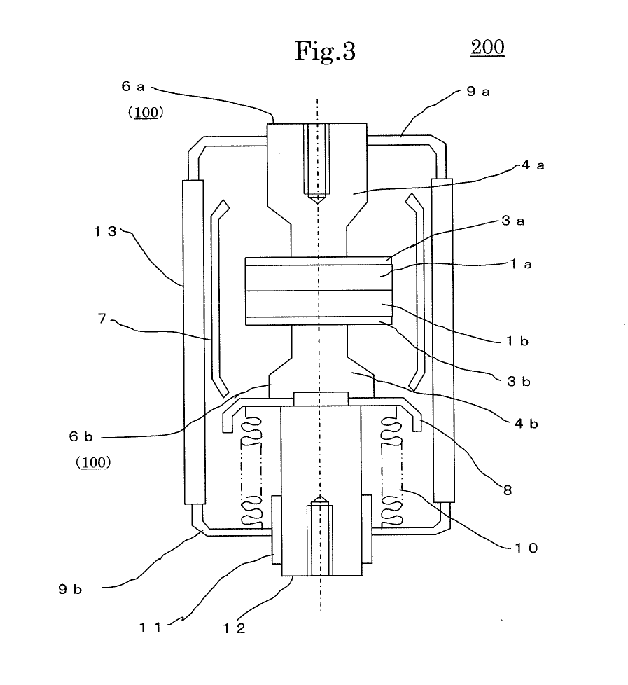

A vacuum interrupter 200 was manufactured by using the electrode 100 manufactured in embodiment 1. FIG. 3 is a sectional view showing the structure of a vacuum interrupter according to this embodiment. In FIG. 3, 1a is an electrical contact of a fixed side, 1b is an electrical contact of movable side, 3a,3b is a reinforcing plate, 4a is a welding rod of the fixed side, 4b is welding rod of the movable side; by these, an electrode of the fixed side 6a and an electrode of the movable side 6b (100) is created. In this embodiment, the electric contacts are disposed so as to connect the groove of the electric contact of the movable side and the groove of the electric contact of the fixed side to each other. The electrode of the movable side 6b was brazed the holder of movable side 12 through a shield of movable side 8 to prevent from scattering metal vapor at cut off. These were brazed in a high vacuum by end plate on the fixed side 9a, end plate of the movable side 9b and insulation tube 13, and were connected to the outer connector by the screw part of the electrode on the fixed side 6a and the holder on the movable side 12.

The shield 7 is disposed inner surface of the insulation tube 13 to prevent scattering metal vapor at the cut off. There is a guide 11 between the end plate on the fixed side 9a and the holder of the movable side 12 to support the sliding parts. There are bellows 10 between the shield of the movable side 8 and the end plate of the fixed side 9a to move the holder of the movable side 12 up and down in a vacuum interrupter, and open and close the electrode of the fixed side 6a and the electrode of movable side 6b.

A vacuum interrupter 200 was manufactured by applying the electrical contacts manufactured in the embodiment 1 to electrical contacts 1a, 1b in FIG. 3.

### Embodiment 3

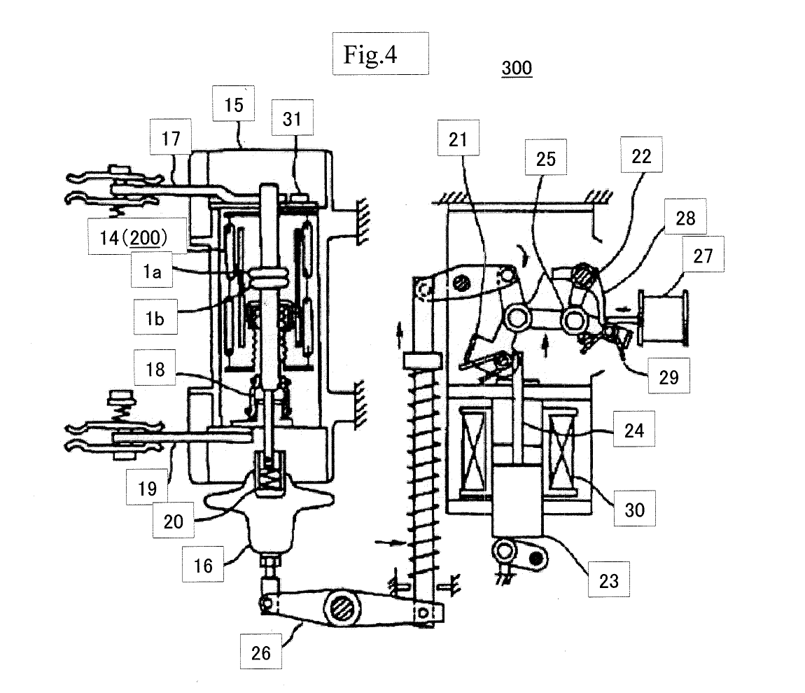

A vacuum contact 300 having vacuum interrupter 200 in embodiment 2 was manufactured. FIG. 4 shows vacuum interrupter 14 (200) and structure chart of vacuum contact 300.

An operation mechanism is disposed in front of the vacuum contactor 300. Three set of epoxy cylinders 15 for bundled three phases that support the vacuum interrupter 14 (200), are disposed on the back face of the vacuum contactor 300. The vacuum interrupter 14 (200) was opened and closed by the operation mechanism through the insulated operating rod 16.

If the vacuum contactor 300 is in a closed state, current flows through the upper terminal 17, electrical contact 1, current collector 18, and the lower terminal 19. Contact force between the electrodes was maintained by the contact spring 20 attached to the insulated operated rod 16. Contact force between the electrodes and electromagnetic force caused by a short circuit current was maintained by the support lever 21 and prop 22. When the closing coil 30 was excited, the plunger 23 pushed up the roller 25 through the knocking rod 24 in the closed state. After between the electrodes was closed by turning the main lever 26, the contact force was maintained by the lever 21.

If the vacuum contactor 300 was in a state for a tripping operation, the tripping coil 27 was excited, the tripping lever 28 removed the engagement of the prop 22, and then the contact between the electrodes was opened by turning the main lever 26.

If the vacuum contactor 300 was in closed state, after opening the contact between the electrodes, a link was returned by the reset spring 29 to operate concurrently with engagement of the prop 22. When the closing coil 30 was excited in this state, the vacuum contactor 300 was closed state.

### Embodiment 4

The electrical contact 1 manufactured in embodiment 1 was applied vacuum interrupter 200 in embodiment 2, this vacuum interrupter 200 was arranged the vacuum contactor 300 in embodiment 3 and a performance test was performed.

Table 1 shows the result of chopping current after cutting off a prescribed number of times at 1.5 kA and quality of withstand voltage performance after interruption (ability to maintain a non-discharge while opening between the electrical contacts).

In Nos. 1 to 5, as described above, since the diameter of the compounds, the ratio of the diameter and length (y/x), orientation and abundance were appropriate range, 1000 times after interruption shows low chopping current (3.5 A or less). In No. 4, electrical contact 1 has a simple disk shape without a slit trench; since removal action of melt layer derived from arc drive was small, high chopping current was shown in comparison with Nos. 1-3 and 5, but there was actually low surge. Maintenance condition of withstand voltage after cut off was fine.

On the other hand, in comparative example No. 6, since the portion of compound particles on the contact surface is small, and the chopping current is greater, it was impossible to obtain enough low surge. In No. 7, since the compounds content was too high, the effect of reducing the chopping current that was accompanied the volatilization of low melting point metal (Te) decomposed by the arc heating, is sufficient. However, volatilized Te adhered to the inner surface of the vacuum interrupter 200, withstand voltage performance after interruption is significantly reduced. In No. 8, it was impossible to obtain enough ratio (y/x) of compounds, the proportion on the contact face was not sufficient. For this reason, supply of low melting point metal (Te) from the base material of the electrical contact cannot continue every time interruption frequency increase, a rise of the chopping current was evident. In No. 9, as described above, since cracking occurred frequently, it was impossible to manufacture enough electrical contacts to evaluate. In No. 10, since stoichiometric composition ratio (Te/Cu) is 0.5, low surge is sufficient at initial cut-off, however the result shows that a rise of chopping current is greater when cut-off frequency increase.

In this way, electrical contacts of examples show low surge and excellent sustainability. In the case of using Cu₃Se₂ as the compound, there is the same effect. Consequently the electrical contact can be inexpensive and have excellent workability. The vacuum switching devices can show to sustain low surge when current cut off frequent.

### [Table 1]

TABLE 1

| | | | | | | Existence form of | | | |
|---|---|---|---|---|---|---|---|---|---|
| | | | | | | compounds which accounts more | | | |
| | | | | | | than 90% (x; diameter, y; length) | | | |
| | | Contact composition | | | Plastic working | | | Angular range to | Proportion |
| | | (wt %) | | Compound | reduction of | x | | the contact face | (Number/ |
| Division | No. | Cu | Compound | component | area (%) | (μm) | y/x | (°) | 0.01 mm²) |
| Products of | 1 | 96.8 | 3.2 | Cu₇Te₄ | 75 | 4~12 | 2~9 | 90 ± 2 | 9 |
| invention | 2 | 92.6 | 7.4 | Cu₇Te₄ | 75 | 2~13 | 2~10 | 90 ± 3 | 16 |
| | 3 | 90.3 | 9.7 | Cu₇Te₄ | 75 | 4~14 | 2~9 | 90 ± 5 | 21 |
| | 4 | 92.6 | 7.4 | Cu₇Te₄ | 75 | 2~13 | 2~10 | 90 ± 3 | 16 |
| | 5 | 92.9 | 7.1 | CuTe | 75 | 2~12 | 2~9 | 90 ± 3 | 18 |
| Comparative | 6 | 98.6 | 1.4 | Cu₇Te₄ | 75 | 3~13 | 2~9 | 90 ± 3 | 4 |
| products | 7 | 87.5 | 12.5 | Cu₇Te₄ | 75 | 5~15 | 2~8 | 90 ± 4 | 31 |
| | 8 | 92.6 | 7.4 | Cu₇Te₄ | 65 | 8~24 | 1~4 | 90 ± 40 | 5 |
| | 9 | 92.6 | 7.4 | Cu₇Te₄ | 90 | 1~9 | 3~13 | 90 ± 1 | 27 |
| | 10 | 92.3 | 7.7 | Cu₂Te | 75 | 2~11 | 2~8 | 90 ± 3 | 15 |

| | | | | | | Maintenance of | |
|---|---|---|---|---|---|---|---|
| | | Contact | | | | the withstand | |
| | | shape | Chopping current after 1.5 kA interruption (A) | | | voltage | |
| | | (Slit | 10 times after | 100 times after | 1000 times after | performance | |
| Division | No. | groove) | interruption | interruption | interruption | after interruption | Remarks |
| Products of | 1 | Yes | 0.8 | 1.7 | 2.9 | ∘ | |
| invention | 2 | Yes | 0.7 | 1.4 | 2.4 | ∘ | |
| | 3 | Yes | 0.5 | 1.1 | 2.2 | ∘ | |
| | 4 | No | 0.7 | 1.9 | 3.2 | ∘ | |
| | 5 | Yes | 0.6 | 1.6 | 2.5 | ∘ | |
| Comparative | 6 | Yes | 1.2 | 2.9 | 5.5 | ∘ | |
| products | 7 | Yes | 0.5 | 0.9 | 1.8 | x | |
| | 8 | Yes | 0.7 | 7.5 | 7.8 | ∘ | |
| | 9 | — | — | — | — | — | The cracks due |
| | | | | | | | to plastic |
| | | | | | | | working |
| | 10 | Yes | 1.5 | 3.7 | 6.1 | ∘ | |

1 Electrical contact
1a Electrical contact of a fixed side
1b Electrical contact of a movable side
2 Slit groove
3,3a,3b Reinforcing plate
4,4a,4b Welding rod
5 Brazing filler metal
6a Electrode of the fixed side
6b Electrode of the movable side
7 Shield
8 Shield of the movable side
9a End plate on the fixed side
9b End plate of the movable side
10 Bellows
11 Guide
12 holder on the movable side
13 Insulating tube
14, 200 Vacuum interrupter
15 Epoxy cylinder
16 Rod
17 Upper terminal
18 Current collector
19 Lower terminal
20 Contact spring
21 Support lever
22 Prop
23 Plunger
24 Knocking rod
25 Roller
26 Main lever
27 Trip coil
28 Trip lever
29 Reset spring
30 Closing coil
31 Exhaust pipe
44 Center hole
100 Electrode
200 Vacuum interrupter
300 Vacuum contactor

1. An electrical contact includes a Cu matrix, and compounds containing Cu and a low melting point metal that are dispersed in the Cu matrix,
Wherein a vapor pressure of the low melting point metal is more than 10⁵ Pa at 1000° C., where the compound has a stoichiometric ratio that is the value of the low melting metal/Cu is greater than 0.5, and a longitudinal direction of the compound is oriented at an angle of 90°±10° to the contact surfaces.

2. The electrical contact according to claim 1, wherein the low melting point metal is Te or Se.

3. The electrical contact according to claim 1, wherein a content ratio of the compound is 3 to 10 weight percent (wt %).

4. The electrical contact according to claim 1, wherein the compound includes at least one of Cu₇Te₄, Cu₄Te₃, CuTe and Cu₃Se₂.

5. The electrical contact according to claim 1, wherein X length in the short side direction of the compound is 2 to 15 μm, ration (Y/X) of Y length in the longitudinal direction of the compound and the X length in the short side direction is 2 to 10.

6. The electrical contact according to claim 1, wherein the compound is distributed parallel surface to the contact surface at a rate of 6/0.01 mm² or more.

7. A method of an electrical contact includes a Cu matrix, and compounds containing Cu and a low melting point metal that are distributed in the Cu matrix, wherein vapor pressure of the low melting point metal is more than 10⁵ Pa at 1000° C., stoichiometric composition ratio (low melting point metal/Cu) of the compound of the low melting point metal with Cu is greater than 0.5, and stretching mixture the Cu matrix with the compounds is at 70-85% while heating, using as a contact surfaces of the electrical contact.

8. Electrode comprising a disk having a center hole formed at the circle center and several penetrated slit grooves are formed toward the outer peripheral portion from the circle center in a non-contact with the center hole, the electrical contact disposed on the arc generation surface of the disc according claim 1, and a electrode bar joined together the opposite side of the electrical contact of the disk.

9. A vacuum interrupter comprising the electrode according to claim 8 at least one of a movable contact and a fixed contact as a contact pair in a vacuum chamber of the vacuum interrupter.

10. A vacuum circuit breaker comprising the vacuum interrupter according to claim 9, an electrically conductive terminal arranged at an outside of the vacuum interrupter and electrically connected to each of the movable contact and the fixed contact in the vacuum interrupter, and an opening and closing means for driving the movable contact.
